(19) United States
(12) Patent Application Publication
(10) Pub. No.: US 2026/0299716 A1
(43) Pub. Date: Oct. 1, 2026

(54) MOUSE SCROLL WHEEL MECHANISM

(71) Applicant: TOPRAY MEMS INC., Hsinchu City (TW)

(72) Inventors: Chin-Sung Liu, Hsinchu City (TW); Chi-Ling Chang, Hsinchu City (TW); Hsiao-Ming Chien, Hsinchu City (TW)

(21) Appl. No.: 19/230,107

(22) Filed: Jun. 6, 2025

(30) Foreign Application Priority Data
Mar. 31, 2025 (TW) 114112358

(51) Int. Cl. G06F 3/0362; G06F 3/03

(52) U.S. Cl. CPC G06F 3/0362; G06F 3/0312

(57) ABSTRACT

A mouse roller mechanism includes: a carrying unit, a roller, a plurality of sheet-shaped magnetic conductive members and a magnet member; the carrying unit is provided with a first mounting member and at least a second mounting member, and the roller is rotatably disposed on the first mounting member; the plurality of sheet-shaped magnetic conductive members have the same shape and are distributed at equal angles and equal intervals around the circumference of the roller, and two adjacent sheet-shaped magnetic conductive members are separated by an non-magnetic conductive object; the magnet member has a magnetic pole side with strong magnetism, and the magnet member is disposed on the second mounting member with the magnetic pole side facing the roller at a distance. When the roller rotates, the intermittent magnetic restoring force generated between the magnet member and the sheet-shaped magnetic conductive member allows users to feel the resistance.

### CROSS-REFERENCE TO RELATED APPLICATION

This application claims the priority of Taiwanese patent application No. 114112358, filed on Mar. 31, 2025, which is incorporated herewith by reference.

### BACKGROUND OF THE INVENTION

### 1. Field of the Invention

The present invention relates generally to the technical field of mouse, and in particular to a mouse scroll wheel mechanism.

### 2. The Prior Arts

The mouse is used to control the cursor on the screen and perform corresponding operations with the computer. In addition to the basic left and right buttons for input, some mice also have auxiliary control wheels. The wheels can be rotated to quickly browse web pages or as an auxiliary operation of the cursor. In order to increase the accuracy of the wheel rotation, a mechanical spring is provided inside the mouse to generate resistance to the wheel, so that the wheel produces an intermittent strong and weak gear feel when rotating. However, this type of structure wheel usually only provides one operation mode, for example, it can only browse line by line. During the process, the wheel is limited to rotating at equal angles and small angles. If the user has other operation modes, the mechanical spring design cannot meet the requirements. For example, to quickly browse web pages, the wheel must rotate half a circle or a medium or large angle. Or for fast sliding in e-sports, the wheel must rotate quickly—at a large angle or more than one circle, which is called flywheel mode. If the above two operation modes are to be met, other electronic controls and additional mechanical components must be used, which makes the internal structure of the mouse complex and the cost increased. In order to solve the above problems, the present invention designs a non-contact mouse scroll wheel mechanism so that the operator can quickly adjust the scroll wheel according to different operation modes.

### SUMMARY OF THE INVENTION

A primary objective of the present invention is to provide a mouse roller mechanism, in particular, a non-contact scroll wheel braking mode, which utilizes the magnetic restoring force generated by the relative movement of a magnet and a sheet-shaped magnetic conductive member and converts the magnetic restoring force into intermittent resistance when the scroll wheel rotates, but reduces the influence of the magnetic force on the scroll wheel rotation. When the operator uses different operation modes, the scroll wheel can meet the corresponding rotation mode, thereby improving the convenience of operation.

To achieve the aforementioned objective, the present invention adopts the following technical solution:

The present invention provides a mouse scroll wheel mechanism, comprising: a carrying unit, a roller, a plurality of sheet-shaped magnetic conductive members and a magnet member, the carrying unit is provided with a first mounting member and at least one second mounting member, the roller is arranged on the first mounting member and can rotate, the plurality of sheet-shaped magnetic conductive members have the same shape and are distributed at equal angles and intervals on the circumference of the roller, and two adjacent sheet-shaped magnetic conductive members are separated by a non-magnetic conductive object; the magnet member has a strong magnetic pole surface, the magnet member is arranged on the second mounting member, and the pole surface faces the roller and is separated by a distance, the magnet member faces the sheet-shaped magnetic conductive member in a non-contact manner, in the moving direction of the sheet-shaped magnetic conductive member facing the magnet member, the body size of the sheet-shaped magnetic conductive member is smaller than the pole size of the magnet member, and when the roller rotates, intermittent strong and weak magnetic restoring forces is generated between the magnet member and the sheet-shaped magnetic conductive member.

In a preferred embodiment, the magnet member has a single set of magnetic poles, and when the roller is in a stopped state without external force, the center line of the sheet-shaped magnetic conductive member is located at the magnetic center line position of the magnet member.

In a preferred embodiment, the magnet member facing the roller is in an arc shape or a square shape.

In a preferred embodiment, the magnet member is fixed to the second mounting member so that the magnet member is located in a radial direction of the roller.

In a preferred embodiment, two second mounting members respectively fix two magnet members so that the two magnet members are symmetrically distributed on both sides of the roller in the radial direction and face the sheet-shaped magnetic conductive member in a non-contact manner.

In a preferred embodiment, the magnet member has at least two sets of magnetic poles, and the magnetic pole surface has at least two magnetic poles with opposite polarities; the body size of the sheet-shaped magnetic conductive member is smaller than the sum of the sizes of the two sets of magnetic poles of the magnet member in the moving direction of the sheet-shaped magnetic conductive member facing the magnet member, and the center line of the sheet-shaped magnetic conductive member is located at the intersection of the two magnetic poles of the magnet member when the roller is in a stopped state without external force.

In a preferred embodiment, the magnet member is fixed to the second mounting member so that the magnet member is located in the radial direction of the roller.

In a preferred embodiment, a plurality of the sheet-shaped magnetic conductive members are arranged in annular intervals on an axial side wall of the circumference of the roller, and the second mounting member fixes the magnet member so that the magnet member is arranged in a direction parallel to the axial direction of the roller, and the pole surface faces the sheet-shaped magnetic conductive member on the axial side wall in a non-contact manner.

In a preferred embodiment, two second mounting members are provided and fix two magnet members respectively, so that the two magnet members are respectively located at the axial position of the roller and are symmetrically distributed.

In a preferred embodiment, the second mounting member is a set of switching mechanisms, and the magnet member is installed on the switching mechanism; the switching mechanism drives the magnet member to approach or move away from the sheet-shaped magnetic conductive member, and the magnet member does not contact the sheet-shaped magnetic conductive member; when the switching mechanism drives the magnet unit away from the magnetic conductive member, the magnetic force of the magnet member on the sheet-shaped magnetic conductive member is eventually released, so that the roller can be easily rotated and stop naturally after the inertial force disappears.

In a preferred embodiment, the second mounting member includes a guide assembly fixed on the carrying unit and a moving member installed on the guide assembly and capable of sliding movement; the magnet member is fixed to a side wall of the moving member facing the roller, and the magnet member does not contact the sheet-shaped magnetic conductive member; the magnet member is moved away from or close to the sheet-shaped magnetic conductive member when the moving member slides on the guide assembly, the guide assembly includes a set of brackets and a plurality of guide rods arranged on the brackets, the brackets are arranged on the carrying unit, and the guide rods penetrate the moving member so that the moving member can move linearly along the guide rods.

In a preferred embodiment, the present invention also includes an auxiliary member, which is located outside the movement path of the moving member away from the roller; the auxiliary member is made of a magnetic conductive or magnetic material; when the moving member moves to face the auxiliary member, the magnet member and the auxiliary member are magnetically attracted to each other to fix the position of the moving member after movement, but the magnet member and the auxiliary member do not contact each other.

In a preferred embodiment, the second mounting member includes a guide assembly, a moving member and a toggle member, the guide assembly is fixed on the carrying unit, the moving member is installed on the guide assembly and capable to slide, the magnet member is fixed to a side of the moving member facing the roller, the toggle member drives the moving member to slide on the guide assembly when being pulled, so that the magnet member is away from or close to the sheet-shaped magnetic conductive member; the toggle member is arranged on the carrying unit and rotates at a small angle, the toggle member has a first end and a second end that are relatively positioned with a rotating shaft as the center, the first end also has a guide groove, and the moving member is provided with a guide column that extends upward, and the guide column is located in the guide groove, wherein, when the second end of the toggle member is pulled, the guide column is restricted to slide in the guide groove, so that the first end pulls the moving member to slide on the guide assembly, thereby controlling the magnet member at the moving member to approach or away from the sheet-shaped magnetic conductive member.

In a preferred embodiment, the present invention also includes a positioning assembly, which includes a positioning member and an elastic ejector pin; the positioning member is arranged on the carrying unit and has a plurality of positioning grooves on the top; the positioning member is located on the rotation path of the toggle member, the elastic ejector pin is installed on the toggle member at the second end side, and the elastic ejector pin has retractable elasticity; the elastic ejector pin moves to the corresponding positioning groove when the toggle member is pulled, thereby fixing the adjusted position of the toggle member.

In a preferred embodiment, the second mounting member includes a fixing member and a connecting rod set, the fixing member is upright on the carrying unit, the connecting rod set is a two-section structure connected by a first connecting rod and a second connecting rod, the first connecting rod and the second connecting rod are respectively pivoted at different positions of the fixing member, the first connecting rod is L-shaped and is pivoted to the fixing member from the bottom position, the second connecting rod is pivoted to the fixing member at the middle position, the magnet member is fixed to the first connecting rod and faces the side wall of the roller, the second connecting rod pulls the first connecting rod to swing when the top end of the second connecting rod is pulled, which synchronously moving the carrying unit away from the roller, and making the magnet member approach or move away from the sheet-shaped magnetic conductive member.

In a preferred embodiment, the present invention also includes an auxiliary member, which is located on the side of the movement path away from the roller after the first connecting rod is moved; the auxiliary member is made of magnetic conductive or magnetic material, the magnet member and the auxiliary member are magnetically attracted to each other when the first connecting rod drives the carrying unit to move hereto, thereby fixing the position of the first connecting rod after swinging, and the magnet member and the auxiliary member are not in contact with each other.

Compared with the prior art, the present invention provides a non-contact mouse scroll wheel mechanism, which utilizes a plurality of sheet-shaped magnetic conductive members disposed spaced apart on the roller and cooperate with a non-contacting magnet member, so that when the operator rotates the roller, an intermittent magnetic restoring force of varying strengths and weaknesses is generated between the magnet member and the sheet-shaped magnetic conductive member, allowing the operator to feel an intermittently loose and tight gear feel, or a semi-flywheel feel that can rotate multiple turns quickly. In addition, by adjusting the distance between the roller and the magnet member, the operator can also sense a flywheel feel that can rotate multiple turns quickly, thereby satisfying the operator's diverse modes in using the mouse.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic planar view of a first basic embodiment of the present invention.

FIG. 2 is a schematic planar view of a second basic embodiment of the present invention.

FIG. 3 is a schematic planar view of a third basic embodiment of the present invention.

FIG. 4 is a schematic view of the force action during operation of the third basic embodiment of the present invention.

FIG. 5 is showing the magnetic restoring force generated when the roller rotates.

FIG. 6A is a partial schematic view of the roller in FIG. 4 rotating 3 degrees.

FIG. 6B is a partial schematic view of the roller in FIG. 4 rotating 7.5 degrees.

FIG. 6C is a partial schematic view of the roller in FIG. 4 rotating 12 degrees.

FIG. 6D is a partial schematic view of the roller in FIG. 4 rotated 15 degrees.

FIG. 7 is a schematic view showing the resistant torque generated when the roller of the present invention rotates.

FIG. 8A is a perspective view of the first embodiment of the present invention.

FIG. 8B is a side view of the first embodiment of the present invention.

FIG. 9A is a perspective view of a second embodiment of the present invention.

FIG. 9B is a side view of the second embodiment of the present invention.

FIG. 10A is a perspective of a third embodiment of the present invention.

FIG. 10B is a side view of the third embodiment of the present invention.

FIG. 11A is a perspective view of a fourth embodiment of the present invention.

FIG. 11B is a side view of the fourth embodiment of the present invention.

FIG. 12A is a perspective view of a fifth embodiment of the present invention.

FIG. 12B is a side view of the fifth embodiment of the present invention.

FIG. 13A is a perspective view of a sixth embodiment of the present invention.

FIG. 13B is a side view of the sixth embodiment of the present invention.

FIG. 14 is a perspective view of a seventh embodiment of the present invention.

FIG. 15 is a schematic view of the movement of the roller and the magnet member of the present invention.

FIG. 16 is showing the distance between the roller and the magnet versus the magnetic restoring force of the present invention.

FIG. 17A is a perspective view of an eighth embodiment of the present invention.

FIG. 17B is a top view of the eighth embodiment of the present invention.

FIG. 18A is a perspective view of a ninth embodiment of the present invention.

FIG. 18B is a top view of the ninth embodiment of the present invention.

FIG. 18C is a side view of the ninth embodiment of the present invention.

FIG. 19A is a perspective view of the tenth embodiment of the present invention.

FIG. 19B is a front view of the tenth embodiment of the present invention.

FIG. 19C is a front view of the tenth embodiment of the present invention in another actuating state.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

Currently, most mice are equipped with a scroll wheel for the operator to scroll, so as to quickly browse web pages or move over a large range. The mouse scroll wheel mechanism of the present invention is such a structure. Since the design focus of the present invention is to provide the operator with a variety of different operating sensations or modes, such as [gear feel], [semi-flywheel feel] and [flywheel feel], the subsequent description focuses on the structural features and why such sensations can be generated. As the electrical control or sensing method inside the mouse is based on the existing technology, the details will not be described here.

The following is an explanation of the terms used in the resent document: [Gear feel]: The intermittent loose and tight tactile sensation that the operator feels when turning the mouse wheel. [Flywheel feel]: When the operator touches the mouse wheel, the wheel can rotate without resistance due to its own inertia, allowing the operator to experience the feeling of multiple fast rotations. [Half-flywheel feel]: When the operator pushes the mouse wheel, the front part of the wheel rotates half a circle or 1-3 circles according to its own inertia, and then stops immediately when the force is balanced.

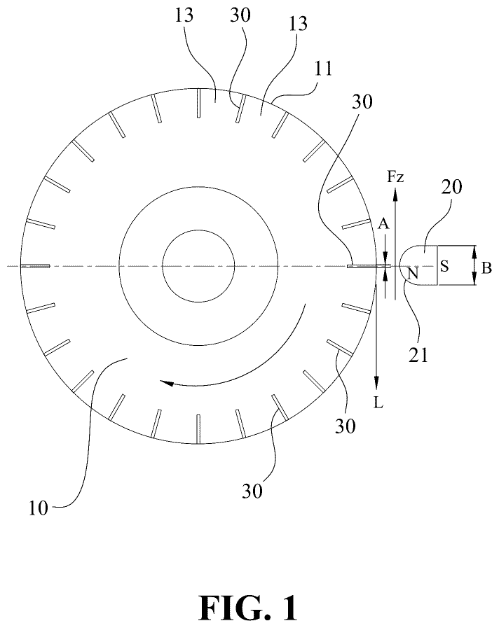

First, the basic structure of the mouse scroll wheel mechanism of the present invention is described, as shown in FIGS. 1, 2 and 3:

The mouse scroll wheel mechanism of the present invention includes a roller 10, a magnet member 20 and a plurality of sheet-shaped magnetic conductive members 30. The plurality of sheet-shaped magnetic conductive members 30 are arranged at intervals on the circumference 11 of the roller 10. Two adjacent sheet-shaped magnetic conductive members 30 are separated by a non-magnetic conductive object 13. In the present embodiment, the roller 10 is made of a non-magnetic conductive material. The plurality of sheet-shaped magnetic conductive members 30 have the same shape, are distributed at equal angles and intervals, and are embedded in the circumference 11 of the roller 10. The magnet member 20 is at a distance from the sheet-shaped magnetic conductive member 30 distributed on the roller 10 and is not in contact with the sheet-shaped magnetic conductive member 30. The magnet member 20 is made of a material that generates a magnetic field, such as a permanent magnet. Both ends of the magnet member 20 have strong magnetic pole surfaces 21, and the pole surfaces 21 face the sheet-shaped magnetic conductive member 30 and are separated by a distance. The body size A of the sheet-shaped magnetic conductive member 30 in the moving direction L of the sheet-shaped magnetic conductive member 30 facing the magnet member 20 must be smaller than the magnetic pole size B of the magnet member 20. The size can be the thickness, length, etc. of the component. Under this structure, when there is no external force, the mouse scroll wheel mechanism of the present invention will produce an obvious stop position when the magnetic restoring force Fz of the magnet member 20 and the sheet-shaped magnetic conductive member 30 is balanced. When the roller 10 is pushed, the magnet member 20 generates a magnetic restoring force Fz on the sheet-shaped magnetic conductive member 30 in the opposite direction of the moving direction L of the sheet-shaped magnetic conductive member 30. The magnetic restoring force Fz allows the operator to feel the resistance from the roller 10. Due to the interval arrangement of the sheet-shaped magnetic conductive members 30, the operator can generate the desired gear feel, or even a semi-flywheel feel, when touching the mouse scroll wheel.

In FIG. 1 to FIG. 3, the sheet-shaped magnetic conductive member 30 and the magnet member 20 can be divided into the following three basic types due to the different installation directions and quantities, and also provide three different stop positions of the roller 10 in the stopped state without external force.

In the first basic embodiment of FIG. 1, the magnet member 20 has only a single set of magnetic poles, and the magnetic poles are in a single direction. In the present embodiment, the magnetic pole surface 21 is an N pole, which faces the sheet-shaped magnetic conductive member 30 in a non-contact manner. When the roller 10 rotates and moves to face the magnet member 20, the sheet-shaped magnetic conductive member 30 is in a horizontal state. In the moving direction L of the sheet-shaped magnetic conductive member 30, the body size A must be smaller than the magnetic pole size B. When the roller 10 is in a stopped state without any external force, the center line of the sheet-shaped magnetic conductive member 30 is located at position of the magnetic center line of the magnet member 20 due to the influence of the balance of the magnetic restoring force Fz. When the roller 10 rotates, the magnet member 20 generates a magnetic restoring force Fz in the opposite direction on the sheet-shaped magnetic conductive member 30, allowing the operator to feel a gear feel or a semi-flywheel feel.

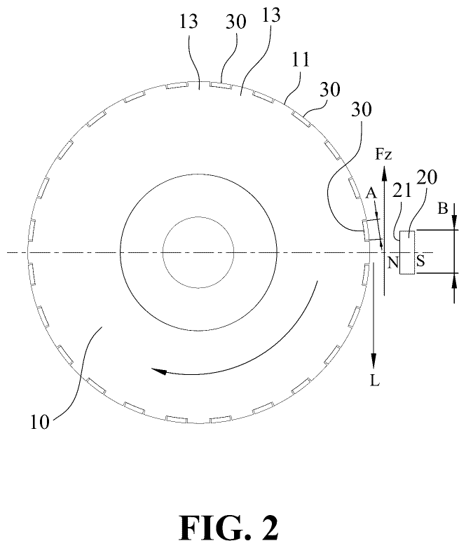

In the second basic embodiment shown in FIG. 2, the magnet member 20 also has a single set of magnetic poles, and the magnetic pole surface 21 is an N pole and faces the sheet-shaped magnetic conductive member 30 in a non-contact manner. In the present embodiment, the sheet-shaped magnetic conductive member 30 is in a vertical state when it moves to face the magnet member 20. In the moving direction L of the sheet-shaped magnetic conductive member 30, the body size A of the sheet-shaped magnetic conductive member must be smaller than the pole size B. Under this structure, because the area of the sheet-shaped magnetic conductive member 30 facing the magnet member 20 is increased, when the roller 10 is in a stopped state without external force, the balance of the magnetic restoring force Fz will make the center line between two adjacent sheet-shaped magnetic conductive members 30 located at the position of the magnetic center line of the magnet member 20. When the roller 10 rotates, the magnet member 20 will generate a magnetic restoring force Fz in the opposite direction on the sheet-shaped magnetic conductive member 30, allowing the operator to feel a gear feel or a semi-flywheel feel.

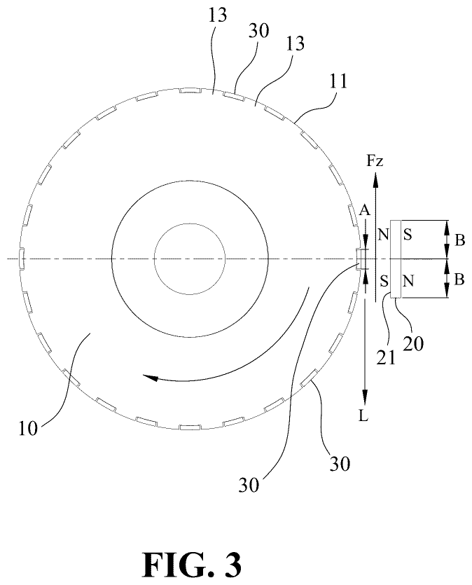

In the third basic embodiment of FIG. 3, the magnet member 20 has a plurality of sets of magnetic poles, and adjacent magnetic poles are opposite to each other. In the present embodiment, the magnetic pole surface 21 has two magnetic poles, for example, the N pole and the S pole are adjacent, and the sheet-shaped magnetic conductive member 30 is in a vertical state when it moves to face the magnet member 20. In the moving direction L of the sheet-shaped magnetic conductive member 30, the body size A is smaller than the sum of the two sets of magnetic pole sizes B, that is, A<2*B. When the roller 10 is in a stopped state without any external force, the center line of the sheet-shaped magnetic conductive member 30 is located at the intersection of the two magnetic poles of the magnet member 20 due to the balance of the magnetic restoring force Fz. When the roller 10 rotates, the magnet member 20 will generate a magnetic restoring force Fz in the opposite direction on the sheet-shaped magnetic conductive member 30, allowing the operator to feel a gear feel or a semi-flywheel feel.

In the above basic embodiments, in the embodiment of FIG. 3, because the magnet member 20 are symmetrically arranged magnets, the magnetic attraction forces of adjacent magnets can even offset each other and become zero. At this time, the roller 10 can roll under zero positive force and the maximum value of the magnetic restoring force Fz, thereby obtaining the best user experience. The following will take this embodiment as an example to explain the operating principle of the present invention:

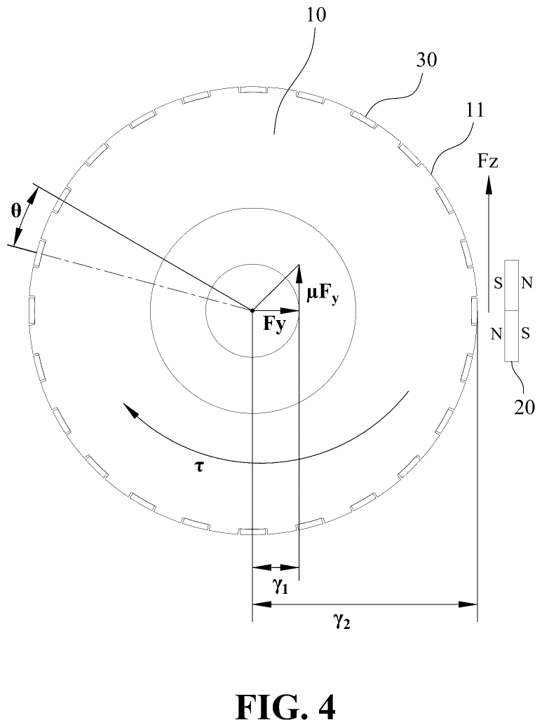

As shown in FIG. 4, in the mouse scroll wheel mechanism of the present invention, the magnet member 20 generates a magnetic restoring force Fz and a magnetic attraction force Fy on the sheet-shaped magnetic conductive member 30. The magnetic attraction force Fy generates a friction force Fy on the rotating shaft. According to the following formula, the resistant torque T formed by the magnetic restoring force and the friction force when the roller 10 rotates can be calculated. The calculation formula is as follows:

$$τ = μ Fy \cdot γ 1 + Fz \cdot γ 2 = Fz \cdot γ 2$$

τ: resistant torque
μ: Dynamic friction coefficient between shaft and bearing
Fy: Magnetic attraction of the magnet to the magnetic conductive member
Fz: Magnetic restoring force
γ 1: Radius of the shaft
γ 2: The radius of the roller

When the roller 10 rotates, the magnetic restoring force Fz and the friction force Fy generated by the magnetic attraction force Fy will jointly form a resistant torque T. The design of the present invention can minimize the magnetic attraction force between the sheet-shaped magnetic conductive member 30 and the magnet member 20, and increase the magnetic restoring force Fz. As such, since the magnetic attraction force Fy is small, the friction force when the roller 10 rotates is also small. The magnetic restoring force Fz is large, and the relative resistance to rotation will also increase. Therefore, the operator will have a clear gear feel when rotating the roller 10. That is, the design of the present invention can produce a very clear gear feel under the condition of very small friction. In addition, because the friction is small, when a specific torque is applied, the roller 10 can rotate by half a circle or a large angle, which can easily produce the required half-flywheel feel. The present invention can provide two different operating experiences under a single structure, which is also the focus of the present invention.

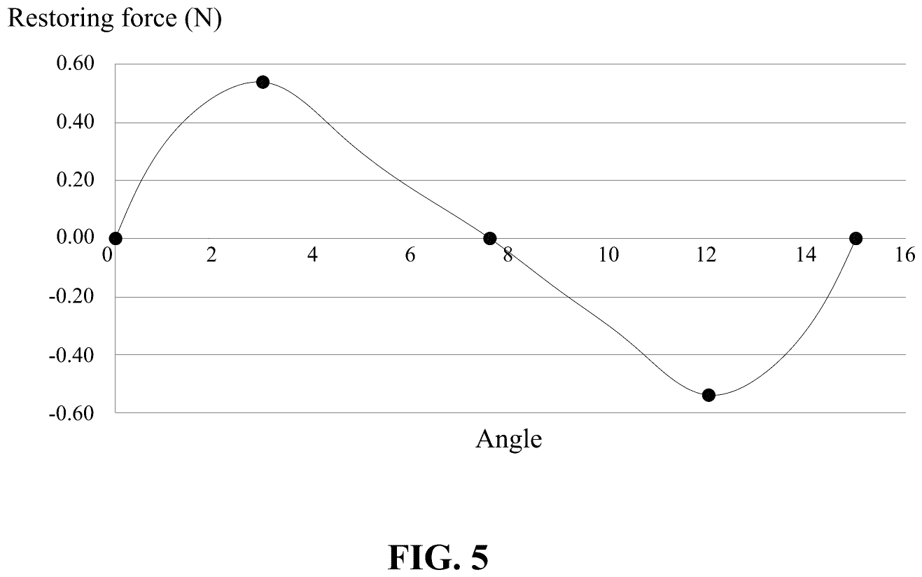

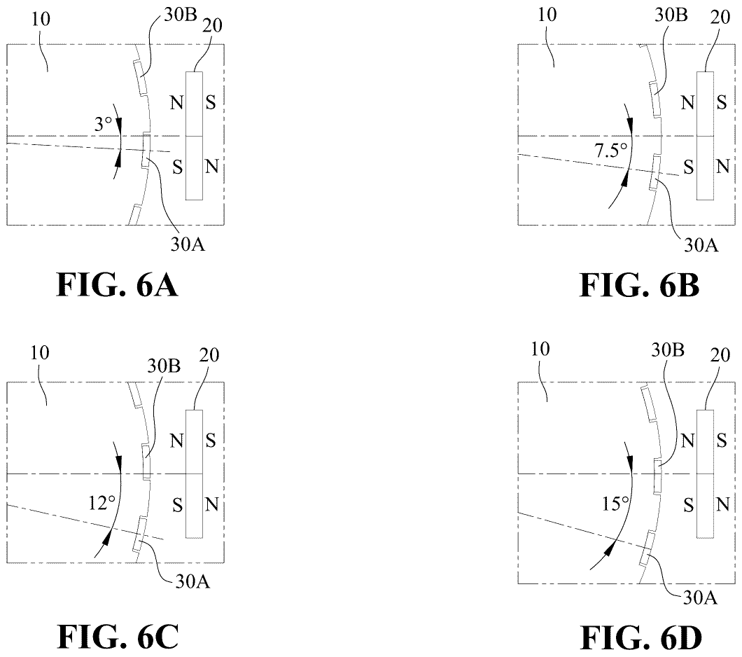

In order to prove that the mouse scroll wheel mechanism of the present invention indeed allows the operator to feel a clear gear feel, actual cases and experimental data are used for illustration below. In the present embodiment, as shown in FIG. 4, 24 sheet-shaped magnetic conductive members 30 are evenly distributed on the circumference 11 of the roller 10, so that the angle θ between the center of adjacent sheet-shaped magnetic conductive members 30 and the center of the roller 10 is 15 degrees. FIG. 5 shows the magnetic restoring force curve generated when the roller 10 rotates. FIGS. 6A, 6B, 6C and 6D are schematic views of the local structure of the roller 10 corresponding to FIG. 5 when the roller 10 rotates 3 degrees, 7.5 degrees, 12 degrees and 15 degrees, respectively. For the convenience of explanation, two adjacent sheet-shaped magnetic conductive members in FIG. 6A to FIG. 6D are defined as the first magnetic conductive member 30A and the second magnetic conductive member 30B, respectively.

As seen in the figures, when the roller 10 starts to rotate, the first magnetic conductive member 30A leaves the stopped position, and the magnetic restoring force begins to increase and generate resistance. This resistance will gradually increase with the rotation, as shown in FIG. 6A, until it reaches a maximum value at 3 degrees, and then the resistance gradually decreases. As shown in FIG. 6B, until the rotation angle reaches 7.5 degrees, the first magnetic conductive member 30A and the second magnetic conductive member 30B are symmetrical to the magnet member 20, and the resistance is zero at this time. At this time, if the roller 10 continues to rotate, the second magnetic conductive member 30B gradually approaches the magnet member 20 and is attracted. Also, the magnetic restoring force will turn into a negative value, forming a thrust, and this thrust will gradually increase with the rotation; as shown in FIG. 6C, until the rotation angle reaches 12 degrees, where it reaches a peak value, and then the thrust will gradually decrease. As shown in FIG. 6D, until the rotation angle reaches 15 degrees, the second magnetic conductive member 30B comes to the neutral position, and the magnetic restoring force is zero.

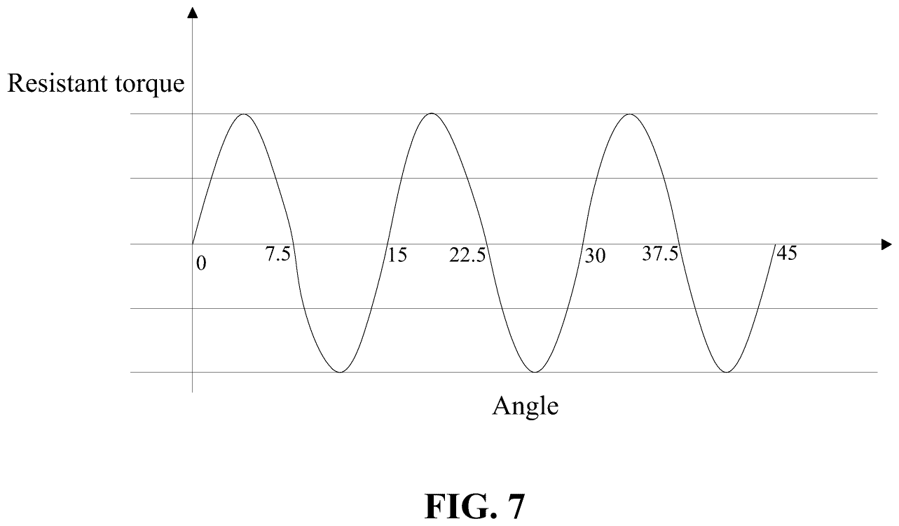

FIG. 7 is a schematic view of the resistant torque generated when the roller 10 rotates 45 degrees. As shown in FIG. 7, each rotation of 15 degrees is a cycle, and the operator will experience a segmented sensation of resistance first and then thrust. If the roller 10 is rotated continuously, the operator will sense a clear gear feel. In addition, the conventional mechanical contact roller is difficult to rotate at a large angle by applying force at one time because of the strong restriction generated by the spring. In the mouse scroll wheel mechanism of the present invention, since the gear feel of rotation comes from the non-contact magnetic resistance mechanism, the operator can apply force once to make the roller 10 rotate at a large angle or more than one circle, such as in a half-flywheel mode, allowing the operator to add another operating mode between the gear feel and the flywheel feel.

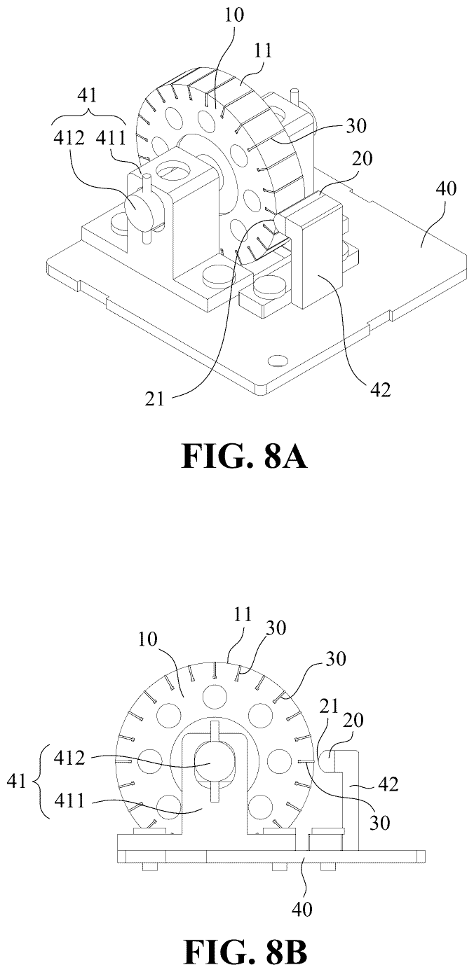

Next, a specific implementation of the present invention is described. As shown in FIGS. 8A and 8B, a first embodiment of the present invention is formed by taking FIG. 1 as the main framework. The mouse scroll wheel mechanism of the present invention includes a roller 10, a magnet member 20, a plurality of sheet-shaped magnetic conductive members 30 and a carrying unit 40. The carrying unit 40 is provided with a first mounting member 41 and a second mounting member 42. The roller 10 is disposed on the first mounting member 41 and can rotate. In the present embodiment, the first mounting member 41 is a bearing bracket assembly. The first mounting member 41 includes a support frame 411 disposed on the carrying unit 40 and a rotating shaft 412 mounted on the support frame 411. The rotating shaft 412 is installed at the bearing position at the center of the roller 10 so that the roller 10 can rotate smoothly. In the present embodiment, the position of the magnet member 20 is fixed and must be maintained at a distance from the roller 10, so the second mounting member 42 is upright on the carrying unit 40, and the magnet member 20 is fixed to the second mounting member 42, so that the magnet member 20 is located in the radial direction of the roller 10, and the magnetic pole surface 21 of the magnet member 20 is an arc surface and a single magnetic pole faces the sheet-shaped magnetic conductive member 30. Since the present invention utilizes magnetic restoring force to generate the required resistance, the body size of the sheet-shaped magnetic conductive member 30 in the moving direction must be smaller than the magnetic pole size of the magnet member 20. In addition, in the present embodiment, the sheet-shaped magnetic conductive members 30 are distributed at intervals on the circumference 11 of the roller 10, and the sheet-shaped magnetic conductive members 30 are in a horizontal state when moving to face the magnet member 20. As such, when the operator rotates the roller 10 of the non-contact mouse scroll wheel mechanism of the present invention, the corresponding magnetic restoring force will form a resistance and a thrust, so that the operator can feel the gear feel or semi-flywheel feel transmitted by the roller 10.

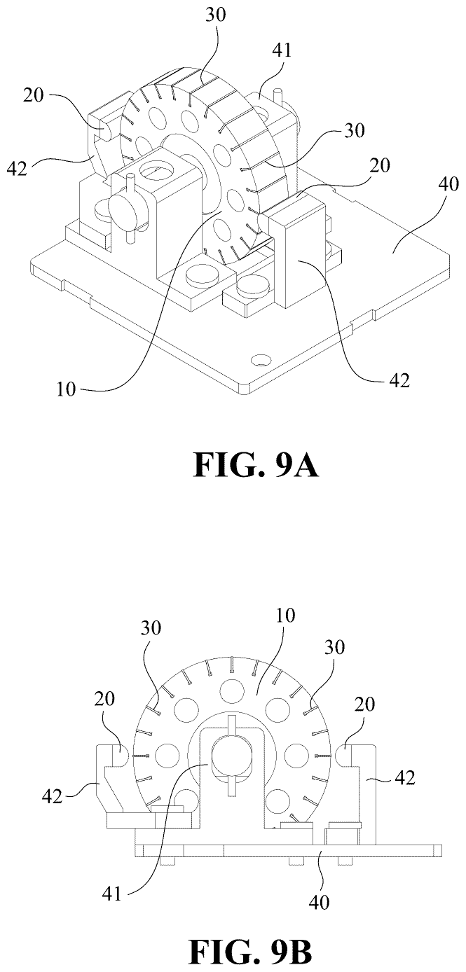

FIG. 9A and FIG. 9B are a perspective view and a side view of a second embodiment of the present invention, respectively. The present embodiment is similar to the first embodiment of FIG. 8A, and still includes a roller 10, a magnet member 20, a plurality of sheet-shaped magnetic conductive members 30 and a carrying unit 40. The difference is that: the carrying unit 40 is provided with two second mounting members 42, and the two second mounting members 42 respectively fix the arc-shaped magnet members 20, so that the two magnet members 20 are symmetrically distributed on both sides of the radial direction of the roller 10, and face the sheet-shaped magnetic conductive member 30 in a non-contact manner. The geometric center line of the magnet member 20 is at the same height as the rotation center of the roller 10. When the roller 10 rotates, the corresponding magnetic restoring force will form a resistance and a thrust, so that the operator can feel a gear feel or a semi-flywheel feel from the roller 10. In the present embodiment, since the two magnet members 20 are symmetrically located on both sides of the radial direction of the roller 10 in a non-contact manner, under the action of the double magnetic restoring force, the gear feel felt by the operator is more obvious than that of the embodiment of FIG. 8A.

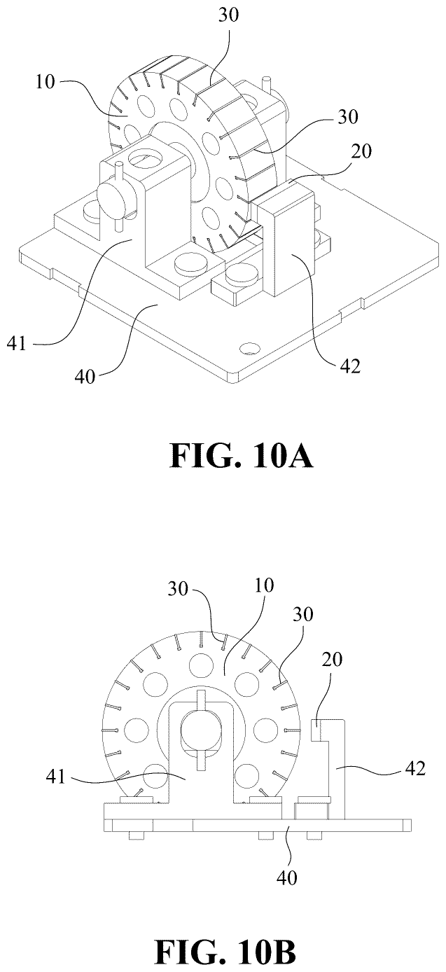

FIG. 10A and FIG. 10B respectively show a perspective view and a side view of the third embodiment of the present invention formed with FIG. 1 as the basic structure. The present embodiment is similar to the first embodiment, and still includes a roller 10, a magnet member 20, a plurality of sheet-shaped magnetic conductive members 30 and a carrying unit 40. The difference is that the magnet member 20 is square in shape. When the roller 10 rotates, the corresponding magnetic restoring force will also form a resistance and a thrust, so that the operator can feel the gear feel transmitted from the roller 10. In the present embodiment, since the magnet member 20 is square, although the magnetic force is smaller than that of the arc-shaped magnet member, the advantage is that the square magnet member 20 is easier to manufacture.

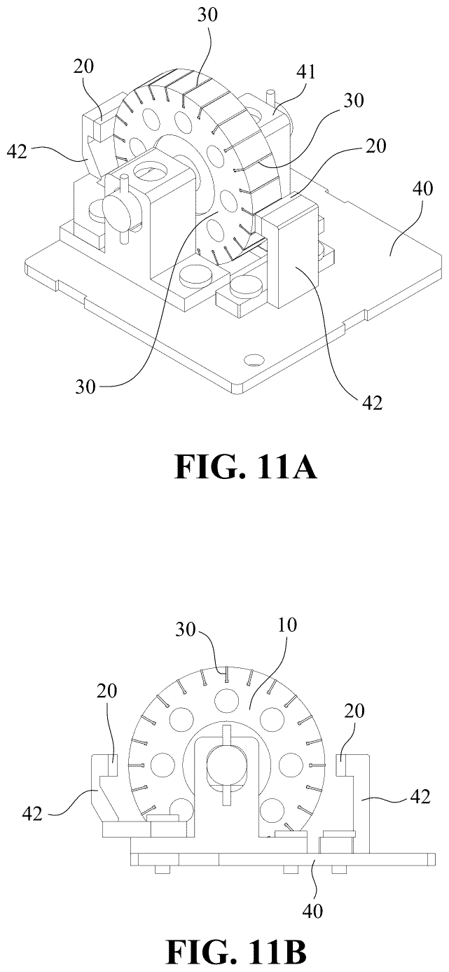

FIG. 11A and FIG. 11B show a perspective view and a side view of the fourth embodiment of the present invention, respectively. The present embodiment is similar to the third embodiment of FIG. 10A, and still includes a roller 10, a magnet member 20, a plurality of sheet-shaped magnetic conductive members 30 and a carrying unit 40. The difference is that: two second mounting members 42 are provided to respectively mount the square magnet members 20 to face the sheet-shaped magnetic conductive members 30 of the roller 10, so that the two magnet members 20 are symmetrically arranged on both sides of the roller 10 in the radial direction, and the geometric center line of the magnet member 20 is at the same height as the rotation center of the roller 10. When the roller 10 rotates, the corresponding magnetic restoring force of this structure will also form a resistance and a thrust, so that the operator can feel the gear feel transmitted from the roller 10.

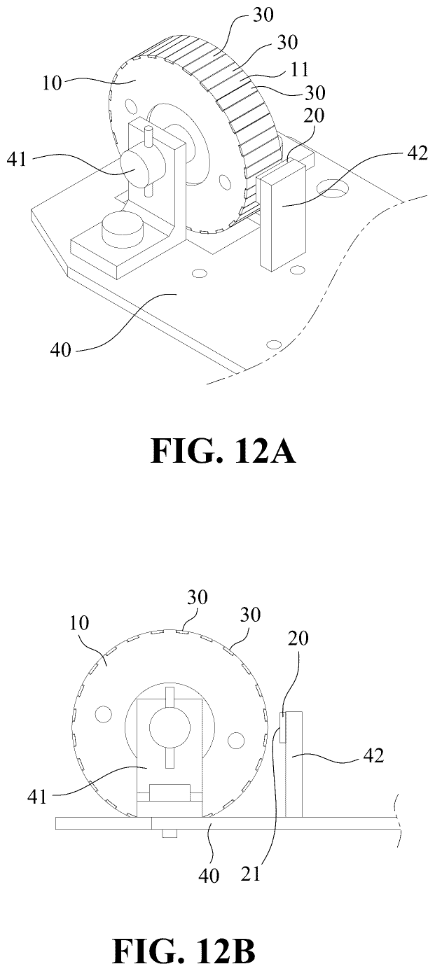

FIG. 12A and FIG. 12B show a fifth embodiment of the present invention formed with FIG. 2 as the basic structure. The mouse scroll wheel mechanism of the present invention still includes: a roller 10, a magnet member 20, a plurality of sheet-shaped magnetic conductive members 30 and a carrying unit 40. The magnetic pole surface 21 of the magnet member 20 is still a single magnetic pole surface. A plurality of sheet-shaped magnetic conductive members 30 are arranged at intervals on the circumference 11 of the roller 10. When the sheet-shaped magnetic conductive member 30 moves to face the magnet member 20, it is in a vertical state. The body size of the sheet-shaped magnetic conductive member 30 in the moving direction is smaller than the magnetic pole size of the magnet member 20. In addition, the geometric center line of the magnet member 20 is at the same height as the rotation center of the roller 10. When the roller 10 rotates, the corresponding magnetic restoring force will also form a resistance and a thrust, so that the operator can feel the gear feel from the roller 10.

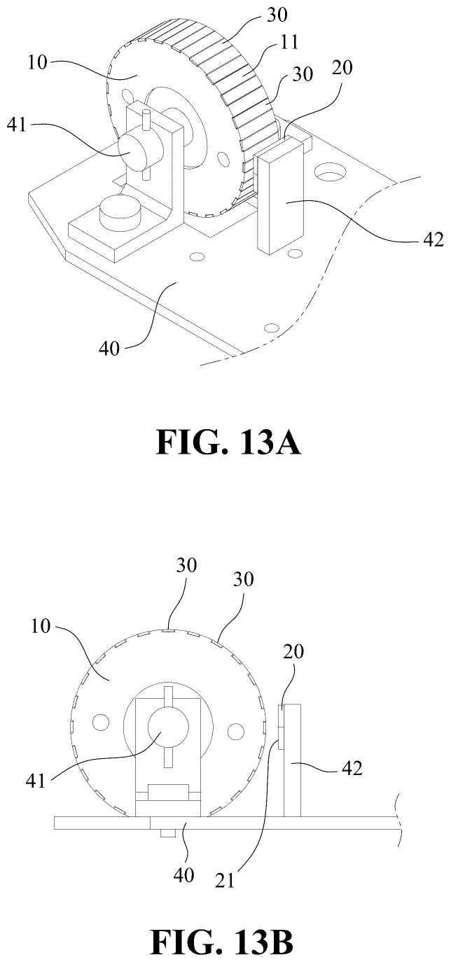

FIG. 13A and FIG. 13B show a sixth embodiment of the present invention formed using FIG. 3 as the basic framework. The mouse scroll wheel mechanism of the present invention still includes a roller 10, a magnet member 20, a plurality of sheet-shaped magnetic conductive members 30 and a carrying unit 40. The carrying unit 40 is provided with a first mounting member 41 and a second mounting member 42. The roller 10 is arranged on the first mounting member 41 and can rotate. The magnet member 20 is fixed to the second mounting member 42 and maintains a distance from the sheet-shaped magnetic conductive member 30 on the circumference of the roller 10. In the present embodiment, the magnetic pole surface 21 of the magnet member 20 has a double magnetic pole, which is formed by two magnets with opposite magnetic poles, but it is not limited thereto. A single magnet can also form a pattern with opposite adjacent magnetic poles. A plurality of sheet-shaped magnetic conductive members 30 are disposed at intervals on the circumference 11 of the roller 10. The sheet-shaped magnetic conductive members 30 are in a vertical state when moving to face the magnet member 20. The body size of the sheet-shaped magnetic conductive member 30 in the moving direction must be smaller than the sum of the two magnetic pole sizes of the magnet member. The geometric center line of the magnet member 20 is at the same height as the rotation center of the roller 10. When the roller 10 rotates, the magnetic attraction forces of adjacent magnets can even cancel each other out and become zero. At this time, the roller 10 can roll under zero positive force and maximum magnetic restoring force, allowing the operator to sense a stronger gear feel or semi-flywheel feel from the roller 10.

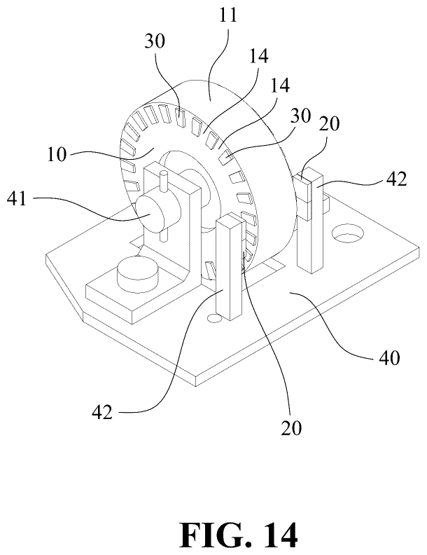

FIG. 14 shows a seventh embodiment of the present invention formed using FIG. 3 as the basic framework. The mouse scroll wheel mechanism of the present invention still includes a roller 10, a magnet member 20, a plurality of sheet-shaped magnetic conductive members 30 and a carrying unit 40. The difference includes that: the plurality of sheet-shaped magnetic conductive members 30 are spaced apart on the axial side walls 14 of the circumference 11 of the roller 10; that is, the plurality of sheet-shaped magnetic conductive members 30 are spaced apart on the axial side walls 14 on both sides of the roller 10, the magnet member 20 also has double magnetic poles, the body size of the sheet-shaped magnetic conductive member 30 in the moving direction is smaller than the sum of the sizes of the two magnetic poles of the magnet component. The magnet member 20 is fixed to the second mounting member 42, so that the two magnet components 20 are respectively located at symmetrical positions in the axial direction of the roller 10. When the roller 10 rotates, the corresponding magnetic restoring force of this structure will also form a resistance and a thrust, so that the operator can feel the gear feel or semi-flywheel feel transmitted from the roller 10.

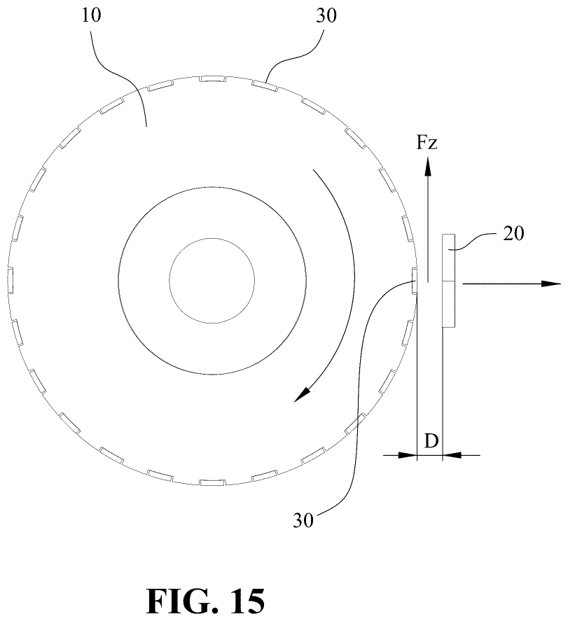

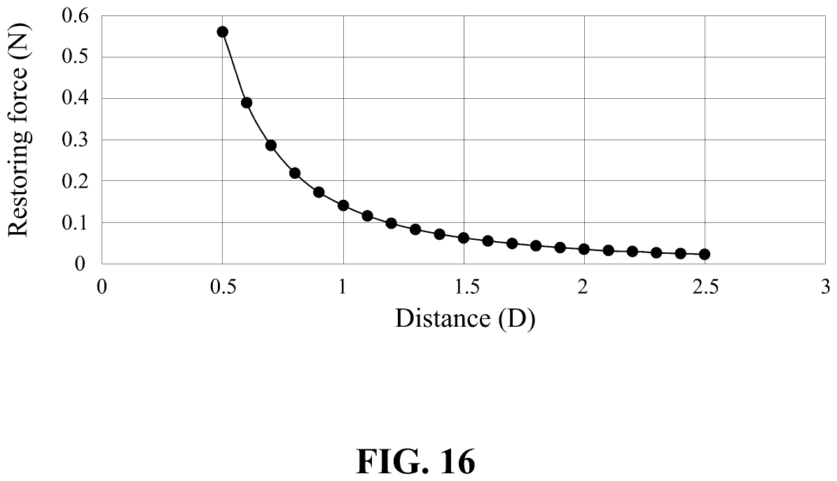

FIG. 15 is a schematic view showing the magnet being away from the roller. FIG. 16 shows the relationship between the distance and the magnetic restoring force when the magnetic member is away from the roller. As shown, the magnetic restoring force Fz of the mouse scroll wheel mechanism of the present invention decreases as the distance D between the magnet member 20 and the sheet-shaped magnetic conductive member 30 of the roller 10 increases. Therefore, the resistant torque generated by the intermittent rotation of the roller 10 becomes smaller, and the gear feel felt by the operator when turning the roller 10 also becomes lighter. When the magnet member 20 is far enough away from the roller 10, there will be no magnetic restoring force between the sheet-shaped magnetic conductive member 30 and the magnet member 20. At this time, the gear feel when the roller 10 rotates completely disappears. The rotating roller 10 can rotate quickly and become a flywheel, which can provide the flywheel feel to the operator.

In the first to seventh embodiments, the magnet member 20 is immovable, so that the operator can feel a gear feel or a semi-flywheel feel when turning the roller 10. However, in the following embodiments, the second mounting member 42 of the present invention is a switching mechanism, which drives the magnet member 20 to gradually approach or move away from the sheet-shaped magnetic conductive member 30, thereby adjusting the strength of the gear feel. When the distance reaches the maximum value, the desired flywheel feel can finally be obtained.

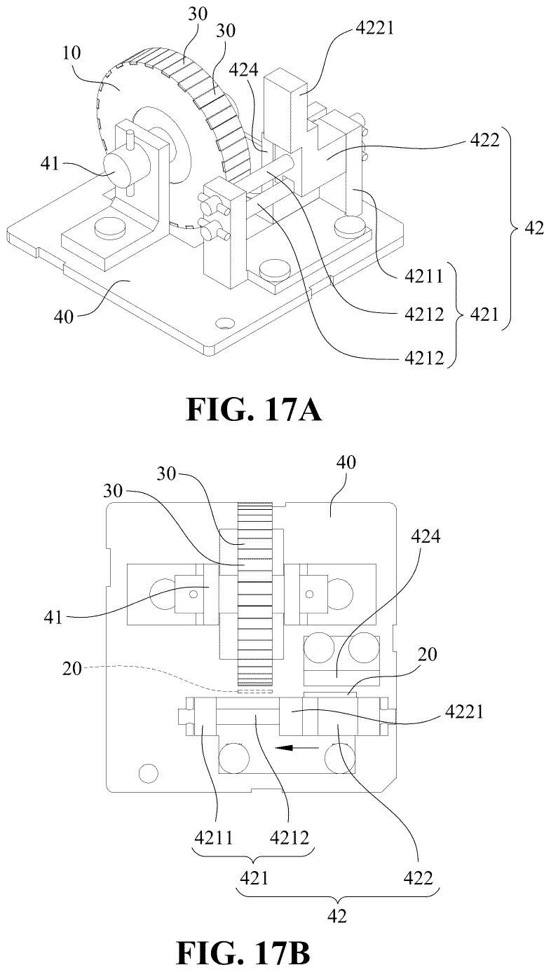

FIG. 17A and FIG. 17B are respectively a perspective view and a top view of the eighth embodiment of the present invention. The mouse scroll wheel mechanism of the present invention comprises a roller 10, a magnet member 20, a plurality of sheet-shaped magnetic conductive members 30 and a carrying unit 40. The structures of the roller 10, the magnet member 20 and the sheet-shaped magnetic conductive members 30 are the same as those in the embodiment of FIG. 13A, except that the second mounting member 42 of the carrying unit 40 is a set of translational switching mechanisms to drive the magnet member 20 to approach or move away from the sheet-shaped magnetic conductive members 30. In the present embodiment, the second mounting member 42 includes a guide assembly 421 fixed on the carrying unit 40 and a moving member 422 installed on the guide assembly 421 and capable of sliding movement. The guide assembly 421 can be a track or a guide rod for the moving member 422 installed thereon to move in a linear direction. In the present embodiment, the guide assembly 421 includes a set of brackets 4211 and two guide rods 4212 arranged on the brackets 4211. The two guide rods 4212 penetrate the block-shaped moving member 422. The moving member 422 has a protrusion 4221 extending upward. Pushing the protrusion 4221 synchronously drives the moving member 422 to move on the guide rod 4212. The magnet member 20 is installed on the moving member 422. To be more precise, the magnet member 20 is installed on the side wall of the moving member 422 facing the roller 10. The magnetic pole surface 21 of the magnet member 20 also has two magnetic poles with opposite polarities. As shown in FIG. 17B, when the moving member 422 moves to the rightmost position, the magnetic restoring force is the weakest or is zero. At this time, the operator can easily rotate the roller 10 and feel the flywheel feel of multiple turns. If the moving member 422 moves to the leftmost position, the magnet member 20 (such as the dotted line position) faces the sheet-shaped magnetic conductive member 30, and the magnetic restoring force is the strongest. The operator can experience the gear feel or the semi-flywheel feel when rotating the roller 10. In the present embodiment, the moving member 422 moves in a direction parallel to the axial direction of the roller 10, but the present invention is not limited thereto. If its position is adjusted, the moving member 422 may also move in a direction parallel to the radial direction of the roller 10.

In addition, in order to prevent the moving member 422 from moving arbitrarily after moving to the rightmost position, the present embodiment further includes an auxiliary member 424. In the present embodiment, the auxiliary member 424 is located on the side of the movement path of the moving member 422 away from the roller 10. The auxiliary member 424 is made of a magnetic conductive or magnetic material. When the moving member 422 moves there, the magnet member 20 and the auxiliary member 424 are magnetically attracted to each other to fix the position of the moving member 422 after the movement. However, it should be noted that the magnet member 20 and the auxiliary member 424 do not contact each other.

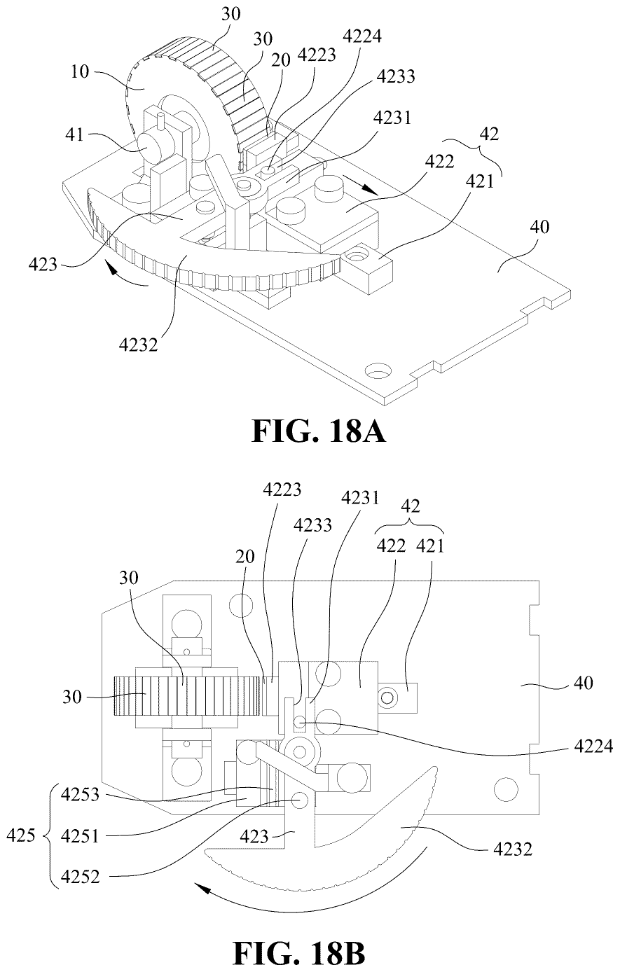

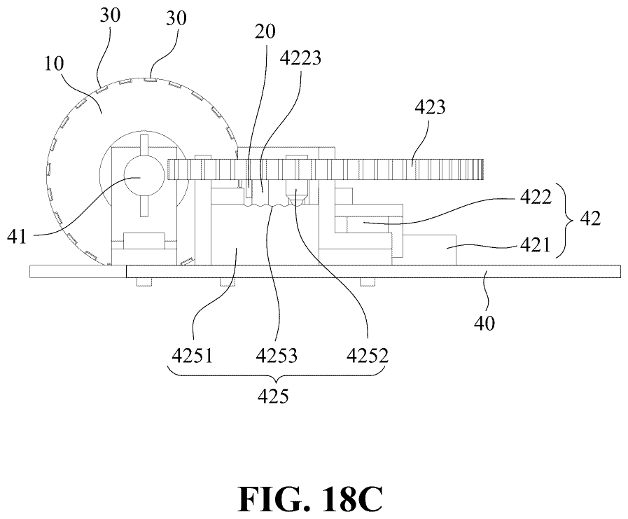

FIGS. 18A, 18B and 18C are respectively a perspective view, a top view and a side view of the ninth embodiment of the present invention. The mouse scroll wheel mechanism of the present invention still includes a roller 10, a magnet member 20, a plurality of sheet-shaped magnetic conductive members 30 and a carrying unit 40. The structures of the roller 10, the magnet member 20 and the sheet-shaped magnetic conductive members 30 are the same as those in the embodiment of FIG. 13A, except that the second mounting member 42 is another type of switching mechanism to drive the magnet member 20 to approach or move away from the sheet-shaped magnetic conductive member 30. In the present embodiment, the second mounting member 42 includes a guide assembly 421, a moving member 422 and a toggle member 423. In the present embodiment, the guide assembly 421 is a set of slide rails arranged on the carrying unit 40, the moving member 422 is installed on the guide assembly 421 and can slide, and the magnet member 20 is fixed to the side wall of the moving member 422 facing the roller 10. Specifically, the magnet member 20 is fixed to the side wall of the carrier plate 4223 extending upward from the moving member 422 facing the roller 10, so that the magnet member 20 faces the sheet-shaped magnetic conductive member 30 of the roller 10 in a non-contact manner. The toggle member 423 is installed on the carrying unit 40 and can be rotated for a small angle. When the toggle member 423 is pulled, it can drive the moving member 422 to slide on the guide assembly 421, so that the magnet member 20 is away from or close to the sheet-shaped magnetic conductive member 30. The toggle member 423 has a first end 4231 and a second end 4232 that are positioned opposite to each other with the rotating shaft as the center. The first end 4231 also has a guide groove 4233. The moving member 422 is provided with a guide column 4224 that extends upward, and the guide column 4224 is located in the guide groove 4233. When the second end 4232 of the toggle member 423 is pulled, the guide column 4224 is restricted to slide in the guide groove 4233, so that the first end 4231 pulls the moving member 422 to slide on the guide assembly 421, thereby controlling the magnet member 20 on the moving member 422 to approach or move away from the sheet-shaped magnetic conductive member 30.

In the present embodiment, the guide assembly 421 is disposed in the radial direction of the roller 10. Therefore, as the moving member 422 drives the magnet member 20 to gradually move away from the sheet-shaped magnetic conductive member 30, the magnetic restoring force gradually weakens, thereby controlling the strength of the gear feel. Therefore, the present embodiment further includes a set of positioning assembly 425 that cooperate with the toggle member 423 to fix the position of the toggle member 423 after being pulled. As shown in FIG. 18C, the positioning assembly 425 includes a positioning member 4251 and an elastic ejector pin 4252. The positioning member 4251 is disposed on the carrying unit 40 and has a plurality of positioning grooves 4253 on the top. The positioning member 4251 is located on the rotation path of the toggle member 423. The elastic ejector pin 4252 is installed on this side of the second end of the toggle member 423. The elastic ejector pin 4252 is elastic and retractable. The elastic ejector pin 4252 can be pressed against the positioning groove 4253. When the toggle member 423 is pulled, the elastic ejector pin 4252 moves to the corresponding positioning groove 4253, thereby synchronously fixing the adjusted position of the toggle member 423. In addition, the second end 4232 is in an arc-shaped sheet to facilitate the operator to move.

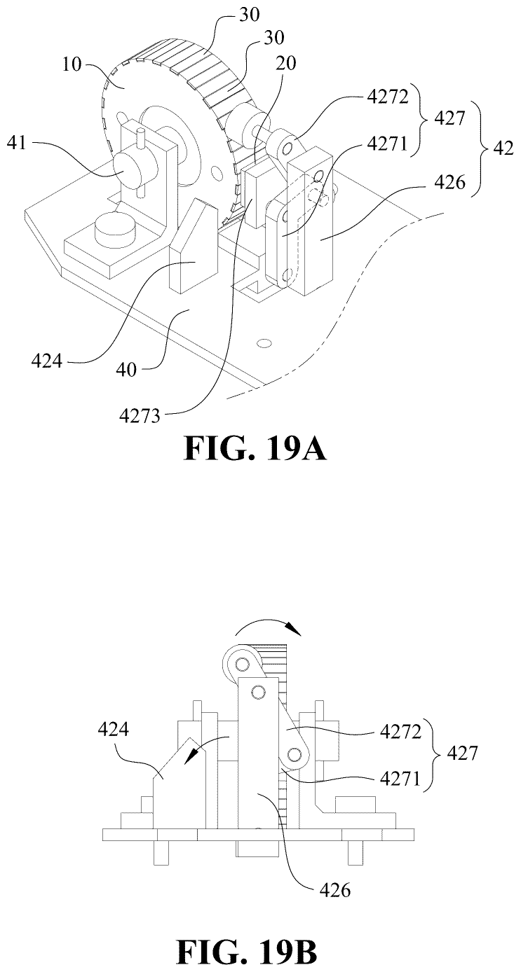

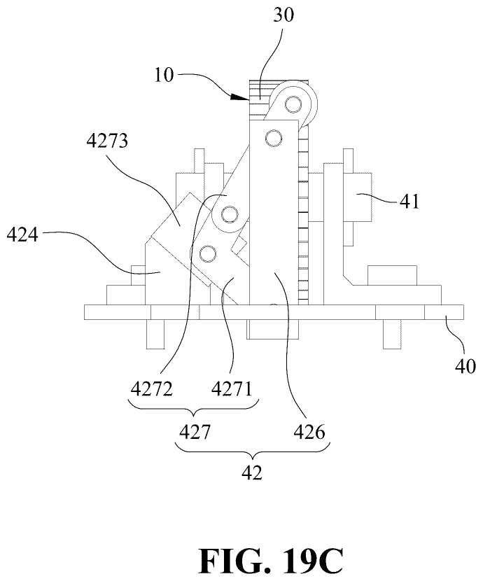

FIG. 19A and FIG. 19B are respectively a perspective view and a front view of the tenth embodiment of the present invention. The mouse scroll wheel mechanism of the present invention still includes a roller 10, a magnet member 20, a plurality of sheet-shaped magnetic conductive members 30 and a carrying unit 40. The structures of the roller 10, the magnet member 20 and the sheet-shaped magnetic conductive members 30 are the same as those of the embodiment of FIG. 13A, except that the second mounting member 42 is a multi-link switching mechanism, the second mounting member 42 includes a fixing member 426 and a connecting rod set 427, the fixing member 426 is upright on the carrying unit 40, the connecting rod set 427 is a two-section structure connected by a first connecting rod 4271 and a second connecting rod 4272, the first connecting rod 4271 and the second connecting rod 4272 are respectively pivoted to different positions of the fixing member 426. The first connecting rod 4271 is L-shaped and is pivoted to the fixing member 426 from the bottom position, the second connecting rod 4272 is pivoted to the fixing member 426 at the middle position, and the magnet member 20 is fixed to the first connecting rod 4271 and faces the side wall of the roller 10. Specifically, the magnet member 20 is fixed to the side wall of a carrier 4273 extending from the first connecting rod 4271, so that the magnet member 20 faces the sheet-shaped magnetic conductive member 30 arranged on the roller 10 in a non-contact manner. As shown in FIG. 19C, when the top end of the second connecting rod 4272 is pulled, the second connecting rod 4272 pulls the first connecting rod 4271 to swing, and simultaneously moves the carrier 4273 away from the roller 10, so that the magnet member 20 can move closer to or away from the sheet-shaped magnetic conductive member 30.

The present embodiment includes an auxiliary member 424. The auxiliary member 424 is located on a side of the movement path away from the roller 10 after the first connecting rod 4271 is moved. The auxiliary member 424 is made of a magnetic conductive or magnetic material. When the first connecting rod 4271 drives the carrier 4273 to move here, the magnet member 20 and the auxiliary member 424 are attracted to each other to fix the position of the first connecting rod 4271 after swinging. However, it should be noted that the magnet member 20 and the auxiliary member 424 do not contact each other.

In summary, the eighth to tenth embodiments of the present invention design the second mounting member 42 as different switching mechanisms to drive the magnet member 20 to approach or move away from the sheet-shaped magnetic conductive member 30. During the process, as the distance between the magnet member 20 and the sheet-shaped magnetic conductive member 30 gradually increases, the operator will sense a gear feel or a half-gear feel of different strengths when turning the roller 10. When the distance is at the maximum, the operator can easily turn the roller 10 and sense the flywheel feel of multiple turns, thereby meeting the needs of different modes for the operator.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A mouse scroll wheel mechanism, comprising:
a carrying unit, a roller, a plurality of sheet-shaped magnetic conductive members and a magnet member;
wherein the carrying unit is provided with a first mounting member and at least one second mounting member, the roller is arranged on the first mounting member and can rotate, the plurality of sheet-shaped magnetic conductive members have the same shape and are distributed at equal angles and intervals on the circumference of the roller, and two adjacent sheet-shaped magnetic conductive members are separated by a non-magnetic conductive object; the magnet member has a strong magnetic pole surface, the magnet member is arranged on the second mounting member, and the pole surface faces the roller and is separated by a distance, the magnet member faces the sheet-shaped magnetic conductive member in a non-contact manner, in the moving direction of the sheet-shaped magnetic conductive member facing the magnet member, the body size of the sheet-shaped magnetic conductive member is smaller than the pole size of the magnet member, and when the roller rotates, intermittent strong and weak magnetic restoring forces is generated between the magnet member and the sheet-shaped magnetic conductive member.

2. The mouse scroll wheel mechanism according to claim 1, wherein the magnet member has a single set of magnetic poles, and when the roller is in a stopped state without external force, the center line of the sheet-shaped magnetic conductive member is located at the magnetic center line position of the magnet member.

3. The mouse scroll wheel mechanism according to claim 2, wherein the magnet member facing the roller is in an arc shape or a square shape.

4. The mouse scroll wheel mechanism according to claim 2, wherein the magnet member is fixed to the second mounting member so that the magnet member is located in a radial direction of the roller.

5. The mouse scroll wheel mechanism according to claim 2, wherein two second mounting members respectively fix two magnet members so that the two magnet members are symmetrically distributed on both sides of the roller in the radial direction and face the sheet-shaped magnetic conductive member in a non-contact manner.

6. The mouse scroll wheel mechanism according to claim 1, wherein the magnet member has at least two sets of magnetic poles, and the magnetic pole surface has at least two magnetic poles with opposite polarities; the body size of the sheet-shaped magnetic conductive member is smaller than the sum of the sizes of the two sets of magnetic poles of the magnet member in the moving direction of the sheet-shaped magnetic conductive member facing the magnet member, and the center line of the sheet-shaped magnetic conductive member is located at the intersection of the two magnetic poles of the magnet member when the roller is in a stopped state without external force.

7. The mouse scroll wheel mechanism according to claim 6, wherein the magnet member is fixed to the second mounting member so that the magnet member is located in the radial direction of the roller.

8. The mouse scroll wheel mechanism according to claim 6, wherein a plurality of the sheet-shaped magnetic conductive members are arranged in annular intervals on an axial side wall of the circumference of the roller, and the second mounting member fixes the magnet member so that the magnet member is arranged in a direction parallel to the axial direction of the roller, and the pole surface faces the sheet-shaped magnetic conductive member on the axial side wall in a non-contact manner.

9. The mouse scroll wheel mechanism according to claim 8, wherein two second mounting members are provided and fix two magnet members respectively, so that the two magnet members are respectively located at the axial position of the roller and are symmetrically distributed.

10. The mouse scroll wheel mechanism according to claim 1, wherein the second mounting member is a set of switching mechanisms, and the magnet member is installed on the switching mechanism; the switching mechanism drives the magnet member to approach or move away from the sheet-shaped magnetic conductive member, and the magnet member does not contact the sheet-shaped magnetic conductive member; when the switching mechanism drives the magnet unit away from the magnetic conductive member, the magnetic force of the magnet member on the sheet-shaped magnetic conductive member is eventually released, so that the roller can be easily rotated and stop naturally after the inertial force disappears.

11. The mouse scroll wheel mechanism according to claim 10, wherein the second mounting member includes a guide assembly fixed on the carrying unit and a moving member installed on the guide assembly and capable of sliding movement; the magnet member is fixed to a side wall of the moving member facing the roller, and the magnet member does not contact the sheet-shaped magnetic conductive member; the magnet member is moved away from or close to the sheet-shaped magnetic conductive member when the moving member slides on the guide assembly, the guide assembly includes a set of brackets and a plurality of guide rods arranged on the brackets, the brackets are arranged on the carrying unit, and the guide rods penetrate the moving member so that the moving member can move linearly along the guide rods.

12. The mouse scroll wheel mechanism according to claim 11, further comprising an auxiliary member, located outside the movement path of the moving member away from the roller; wherein the auxiliary member is made of a magnetic conductive or magnetic material; when the moving member moves to face the auxiliary member, the magnet member and the auxiliary member are magnetically attracted to each other to fix the position of the moving member after movement, but the magnet member and the auxiliary member do not contact each other.

13. The mouse scroll wheel mechanism according to claim 10, wherein the second mounting member includes a guide assembly, a moving member and a toggle member, the guide assembly is fixed on the carrying unit, the moving member is installed on the guide assembly and capable to slide, the magnet member is fixed to a side of the moving member facing the roller, the toggle member drives the moving member to slide on the guide assembly when being pulled, so that the magnet member is away from or close to the sheet-shaped magnetic conductive member; the toggle member is arranged on the carrying unit and rotates at a small angle, the toggle member has a first end and a second end that are relatively positioned with a rotating shaft as the center, the first end also has a guide groove, and the moving member is provided with a guide column that extends upward, and the guide column is located in the guide groove, wherein, when the second end of the toggle member is pulled, the guide column is restricted to slide in the guide groove, so that the first end pulls the moving member to slide on the guide assembly, thereby controlling the magnet member at the moving member to approach or away from the sheet-shaped magnetic conductive member.

14. The mouse scroll wheel mechanism according to claim 13, further comprising a positioning assembly, comprising a positioning member and an elastic ejector pin; wherein the positioning member is arranged on the carrying unit and has a plurality of positioning grooves on the top; the positioning member is located on the rotation path of the toggle member, the elastic ejector pin is installed on the toggle member at the second end side, and the elastic ejector pin has retractable elasticity; the elastic ejector pin moves to the corresponding positioning groove when the toggle member is pulled, thereby fixing the adjusted position of the toggle member.

15. The mouse scroll wheel mechanism according to claim 10, wherein the second mounting member includes a fixing member and a connecting rod set, the fixing member is upright on the carrying unit, the connecting rod set is a two-section structure connected by a first connecting rod and a second connecting rod, the first connecting rod and the second connecting rod are respectively pivoted at different positions of the fixing member, the first connecting rod is L-shaped and is pivoted to the fixing member from the bottom position, the second connecting rod is pivoted to the fixing member at the middle position, the magnet member is fixed to the first connecting rod and faces the side wall of the roller, the second connecting rod pulls the first connecting rod to swing when the top end of the second connecting rod is pulled, which synchronously moving the carrying unit away from the roller, and making the magnet member approach or move away from the sheet-shaped magnetic conductive member.

16. The mouse scroll wheel mechanism according to claim 15, further comprising an auxiliary member, located on the side of the movement path away from the roller after the first connecting rod moved; wherein the auxiliary member is made of magnetic conductive or magnetic material, the magnet member and the auxiliary member are magnetically attracted to each other when the first connecting rod drives the carrying unit to move hereto, thereby fixing the position of the first connecting rod after swinging, and the magnet member and the auxiliary member are not in contact with each other.
